(19) United States
(12) Patent Application Publication
(10) Pub. No.: US 2026/0149394 A1
(43) Pub. Date: May 28, 2026

(54) MOTOR CONTROL SYSTEM AND MOTOR CONTROL METHOD

(71) Applicant: KYOCERA Document Solutions Inc., Osaka-shi, Osaka (JP)

(72) Inventor: Yusuke Ono, Osaka (JP)

(21) Appl. No.: 19/399,970

(22) Filed: Nov. 25, 2025

(30) Foreign Application Priority Data
Nov. 28, 2024 (JP) 2024-207167

(51) Int. Cl. H02P 3/12; G03G 15/00

(52) U.S. Cl. CPC H02P 3/12; G03G 15/5004; G03G 15/6529

(57) ABSTRACT

A motor control system includes an acquisition portion, a setting portion, and a control portion. The acquisition portion acquires a pulse signal for an instruction about acceleration and deceleration operations on a motor. The setting portion sets a stop frequency for the motor on the basis of a frequency of the pulse signal at time of an acceleration operation on the motor. The stop frequency corresponds to a stop timing of the pulse signal. The control portion executes a stop process of stopping the motor using short-circuit braking in a case where a frequency of the pulse signal at time of a deceleration operation on the motor reaches the stop frequency.

### INCORPORATION BY REFERENCE

This application is based upon and claims the benefit of priority from the corresponding Japanese Patent Application No. 2024-207167 filed on November 28, 2024, the entire contents of which are incorporated herein by reference.

This disclosure relates to a motor control system and a motor control method.

### BACKGROUND

Control for stopping the rotation of a DC brushless motor in a short time includes short-circuit braking. When stopping the rotation of a DC brushless motor, a motor drive control device known as the related art controls the motor to stop the rotation thereof by first stopping a clock signal and waiting for the rotation speed of the DC brushless motor to decrease to a predetermined rotation speed, and starting short-circuit braking when the predetermined rotation speed is reached.

### SUMMARY

A motor control system according to an aspect of this disclosure includes an acquisition portion, a setting portion, and a control portion. The acquisition portion acquires a pulse signal for an instruction about acceleration and deceleration operations on a motor. The setting portion sets a stop frequency for the motor on the basis of a frequency of the pulse signal at time of an acceleration operation on the motor. The stop frequency corresponds to a stop timing of the pulse signal. The control portion executes a stop process of stopping the motor in a case where a frequency of the pulse signal at time of a deceleration operation on the motor reaches the stop frequency.

A motor control method according to another aspect of this disclosure includes an acquisition step, a setting step, and a control step. In the acquisition step, a pulse signal for an instruction about acceleration and deceleration operations on a motor is acquired. In the setting step, a stop frequency for the motor is set on the basis of a frequency of the pulse signal at time of an acceleration operation on the motor. The stop frequency corresponds to a stop timing of the pulse signal. In the control step, the motor is stopped in a case where a frequency of the pulse signal at time of a deceleration operation on the motor reaches the stop frequency.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram showing a configuration of an image forming apparatus according to an embodiment.

FIG. 2 is a block diagram showing the configuration of the image forming apparatus according to the embodiment.

FIG. 3 is an explanatory diagram of a motor control system according to a comparative example.

FIG. 4 is an explanatory diagram of a pulse signal according to the embodiment.

FIG. 5 is a flowchart showing an operation example of the motor control system according to the embodiment.

FIG. 6 is a diagram showing a specific operation example of the motor control system according to the embodiment.

### DETAILED DESCRIPTION

Hereinafter, an embodiment of this disclosure will be described with reference to the accompanying drawings. The following embodiment is a specific example of this disclosure and does not intend to limit the technical scope of this disclosure.

### Overall Configuration of Image Forming Apparatus

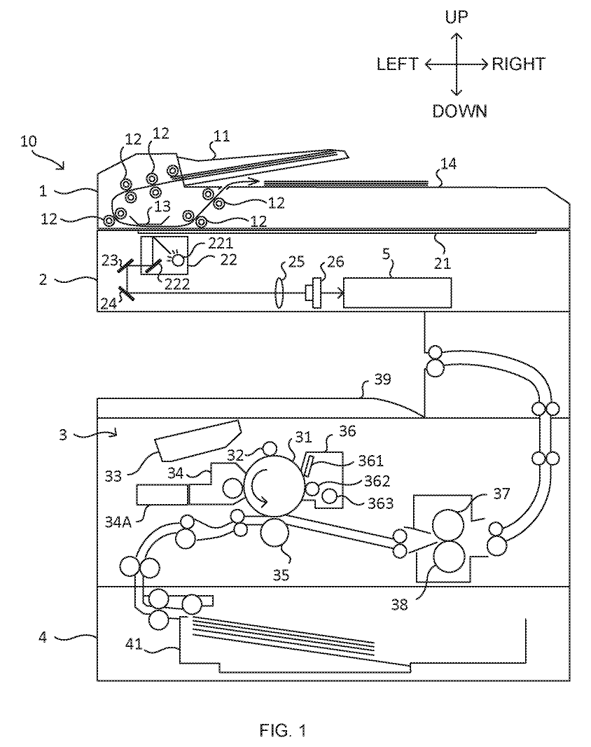

First, the outlined configuration of an image forming apparatus 10 according to this embodiment will be described with reference to FIG. 1. FIG. 1 is a schematic cross- sectional view of the image forming apparatus 10. It is noted that the following description defines the directions up, down, left, and right using arrows indicating the directions in FIG. 1. In addition, the following description defines the foreground side of a diagram as the front of the image forming apparatus 10 and the background side of a diagram as the back of the image forming apparatus 10. Needless to say, the definition of the directions described above does not intend to limit how the image forming apparatus 10 is used.

In this embodiment, the image forming apparatus 10 is, as an example, a multifunction peripheral having a plurality of functions such as a scan function, a facsimile function, and a copy function in addition to a printer function of forming an image on the basis of image data. It is noted that the image forming apparatus 10 may be, for example, an apparatus such as a printer apparatus, a facsimile apparatus, and a copier.

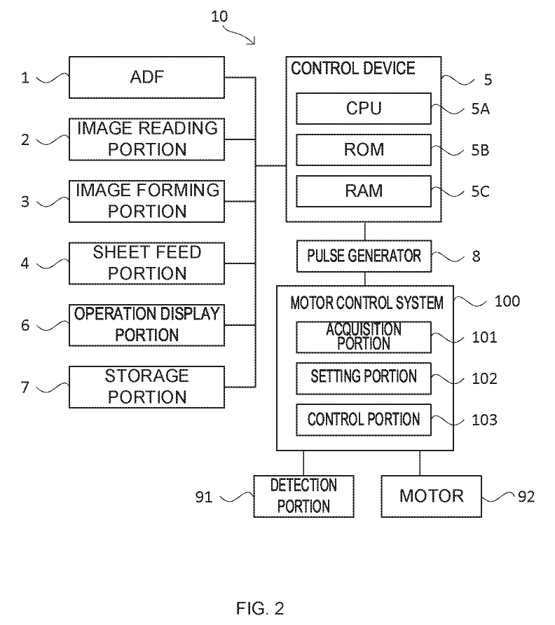

As shown in FIG. 1, the image forming apparatus 10 includes an ADF 1, an image reading portion 2, an image forming portion 3, a sheet feed portion 4, a control device 5, an operation display portion 6 (see FIG. 2), a storage portion 7 (see FIG. 2), a pulse generator 8, a motor control system 100, and the like.

As shown in FIG. 1, the ADF 1 is an automatic document sheet conveying device including a document sheet set portion 11, a plurality of conveying rollers 12, a document sheet holding portion 13, and a sheet discharge portion 14. In the ADF 1, each of the conveying rollers 12 is driven by a motor (not shown) to convey a sheet placed on the document sheet set portion 11 to the sheet discharge portion 14 through the reading position of image data by the image reading portion 2. This allows the image reading portion 2 to read the image data from the sheet conveyed by the ADF 1.

As shown in FIG. 1, the image reading portion 2 includes a document sheet table 21, a reading unit 22, mirrors 23 and 24, an optical lens 25, and a charge-coupled device (CCD) 26. The document sheet table 21 is a placement portion for a sheet. The placement portion is provided on the upper surface of the image reading portion 2. The reading unit 22 includes an LED light source 221 and a mirror 222. The reading unit 22 is movable in a sub-scanning direction (the left-right direction here) using a motor (not shown). The LED light source 221 includes a large number of white LEDs arranged along a main scanning direction (the front-back direction here). The mirror 222 reflects, toward the mirror 23, light emitted from the LED light source 221 and reflected by the surface of a sheet at the reading position on the document sheet table 21. The light reflected by the mirror 222 is then guided to the optical lens 25 by the mirrors 23 and 24. The optical lens 25 condenses the incoming light and causes the condensed light to enter the CCD 26. The CCD 26 includes a photoelectric conversion element or the like that inputs an electrical signal corresponding to the amount of received light coming from the optical lens 25 to the control device 5 as image data of the sheet.

The image forming portion 3 is an electrophotographic image forming portion capable of executing an image formation process (print process) of forming an image on the basis of the image data read by the image reading portion 2. In addition, the image forming portion 3 is also capable of executing an image formation process on the basis of image data received from an information processing apparatus such as an external personal computer.

Specifically, the image forming portion 3 includes a photoconductor drum 31, a charging device 32, a laser scanning unit (LSU) 33, a developing device 34, a transfer roller 35, the cleaning device 36, a fixing roller 37, a pressure roller 38, and a sheet discharge tray 39 as shown in FIG. 1. In the image forming portion 3, an image is then formed, in the following procedures, on a sheet supplied from a sheet feed cassette 41 attachable to and detachable from the sheet feed portion 4 described below and the sheet on which the image is formed is discharged to the sheet discharge tray 39. It is noted that the sheet is paper, coated paper, postcard paper, an envelope, an OHP sheet, or the like.

Hereinafter, an operation of the image forming portion 3 will be described in detail. First, the charging device 32 evenly charges the photoconductor drum 31 at a predetermined potential. Next, the laser scanning unit 33 emits light based on the image data to the surface of the photoconductor drum 31. This forms an electrostatic latent image corresponding to the image data on the surface of the photoconductor drum 31. The electrostatic latent image on the photoconductor drum 31 is then developed (visualized) by the developing device 34 as a toner image. It is noted that the developing device 34 is replenished with toner (developer) from a toner container 34A attachable to and detachable from the image forming portion 3. Subsequently, the toner image formed on the photoconductor drum 31 is transferred to a sheet by the transfer roller 35. After that, the toner image transferred to the sheet is heated, and fused and fixed by the fixing roller 37 when the sheet passes between the fixing roller 37 and the pressure roller 38.

Meanwhile, the toner remaining on the surface of the photoconductor drum 31 is removed by the cleaning device 36. Specifically, the cleaning device 36 includes a cleaning member 361, a polishing roller 362, and a screw 363 as shown in FIG. 1. The cleaning member 361 is a blade-shaped member that removes the remaining toner adhering to the surface of the photoconductor drum 31. The polishing roller 362 sticks the toner removed by the cleaning member 361 to the surface and polishes the surface of the photoconductor drum 31. The screw 363 conveys the toner removed by the cleaning member 361 to a discharge portion (not shown) along the axial direction of the photoconductor drum 31. The toner conveyed to the discharge portion is discharged to a toner storage container (not shown) through a discharge port (not shown) of the discharge portion. The toner storage container is attachable to and detachable from the discharge portion and stores toner.

The sheet feed portion 4 includes the sheet feed cassette 41 and a plurality of conveying rollers 42. The sheet feed cassette 41 is attachable to and detachable from the apparatus body of the image forming apparatus 10. In the sheet feed portion 4, each of the conveying rollers 42 is driven by a motor (not shown) to supply a sheet placed in the sheet feed cassette 41 to the image forming portion 3.

The control device 5 integrally controls the image forming apparatus 10. As shown in FIG. 2, the control device 5 includes a CPU 5A, a ROM 5B, and a RAM 5C. The CPU 5A is a processor that executes various calculation processes. The ROM 5B is a non-volatile storage device that stores, in advance, information about control programs or the like for causing the CPU 5A to execute various processes. The RAM 5C is a volatile storage device that is used as a temporary storage memory (work area) for the various processes which are executed by the CPU 5A.

In the control device 5, the CPU 5A executes the various control programs stored in advance in the ROM 5B. The image forming apparatus 10 is hereby controlled by the control device 5 integrally. It is noted that the control device 5 may be composed of an electronic circuit such as an integrated circuit (ASIC). In addition, the control device 5 may be a control portion provided separately from a main control portion which integrally controls the image forming apparatus 10.

The operation display portion 6 is a user interface of the image forming apparatus 10. The operation display portion 6 includes a display portion such as a liquid-crystal display that displays various kinds of information in response to a control instruction from the control device 5 and an operation portion such as an operation key or a touch panel that inputs various kinds of information to the control device 5 in response to an operation of a user.

The storage portion 7 is a non-volatile storage device. For example, the storage portion 7 is a storage device including a non-volatile memory such as a flash memory and an EEPROM (registered trademark), a solid state drive (SSD), a hard disk drive (HDD), and the like.

The pulse generator 8 is controlled by the control device 5 to generate a pulse signal (also referred to as clock signal) for an instruction about acceleration and deceleration operations on a motor 92 (see FIG. 2). The motor 92 is a control target of the motor control system 100. The pulse generator 8 then supplies the generated pulse signal to the motor control system 100. The motor control system 100 controls the motor 92 in accordance with the pulse signal. In this embodiment, the motor 92 is an inner brushless motor, a brushed motor, or the like. In addition, in this embodiment, the motor 92 is a motor that drives, for example, rollers such as the conveying rollers 12 of the ADF 1 and the conveying rollers 42 of the sheet feed portion 4 that convey a sheet in the image forming apparatus 10. Needless to say, the motor 92 may be a motor that drives, for example, a roller such as the transfer roller 35, the fixing roller 37, or the pressure roller 38 of the image forming portion 3 or the polishing roller 362 of the cleaning device 36.

Here, the acceleration and deceleration operations, in other words, mean driving the motor in a trapezoidal pattern. Specifically, in the acceleration and deceleration operations, the motor is first driven at an initial speed and the motor is accelerated at a predetermined acceleration. When the speed of the motor reaches a predetermined speed, the speed of the motor is kept at the predetermined speed for a certain time and the motor is then decelerated at a predetermined deceleration. The absolute value of the predetermined acceleration is the same as the absolute value of the predetermined deceleration. The motor is then stopped when the speed of the motor reaches the same speed as the initial speed. That is, in the acceleration and deceleration operations, the waveform of the speed of the motor is a substantially bilaterally symmetrical trapezoid. Such acceleration and deceleration operations make it possible to prevent the motor from abruptly changing in speed. It is possible to drive the motor while preventing the motor from stepping out. It is noted that the acceleration and deceleration operations are not limited to driving the motor in a trapezoidal pattern and may be, for example, driving the motor in a triangle pattern or driving the motor in a curved pattern.

Incidentally, control for stopping the rotation of a DC brushless motor in a short time includes short-circuit braking. In addition, the related art described below has been known as a method for controlling a motor that drives, for example, a conveying roller in an image forming apparatus such as the image forming apparatus 10. When stopping the rotation of the motor (DC brushless motor here), this related art stops the motor by first stopping a clock signal (pulse signal) and waiting for the rotation speed of the motor to decrease to a predetermined rotation speed, and starting short-circuit braking in a case where the predetermined rotation speed is reached. The related art, however, keeps the motor rotating for a predetermined time from the stop of the pulse signal to the rotation speed of the motor decreasing to the predetermined rotation speed. The amount of rotation of the motor therefore varies during the predetermined time depending on the load on the motor. This raises a problem that the stop position of the motor tends to vary.

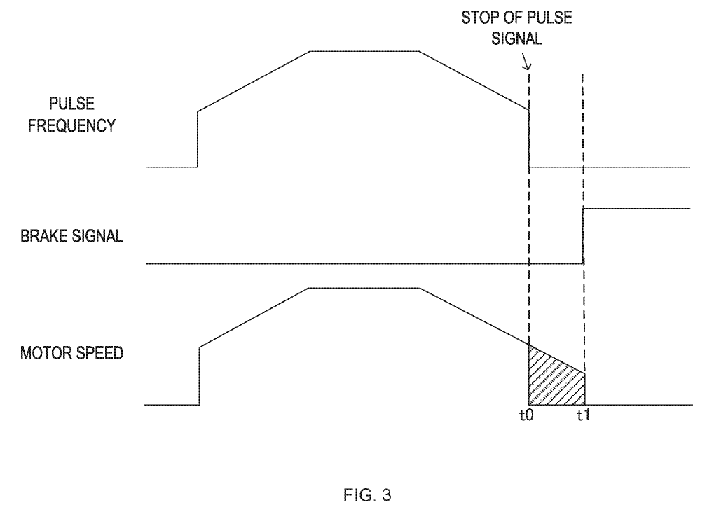

To solve the problem, for example, a method of starting short-circuit braking at the same time as the stop of a pulse signal to stop the motor is conceivable. The following gives description with reference to FIG. 3 using a system that executes the method as a motor control system according to a comparative example. FIG. 3 shows an example in which the motor control system according to the comparative example executes acceleration and deceleration operations on a motor. The upper part of FIG. 3 shows the waveform of the frequency of a pulse signal. The middle part of FIG. 3 shows the waveform of a brake signal. The lower part of FIG. 3 shows the waveform of the speed (rotation speed) of the motor. Here, the brake signal is a binary signal to be supplied to the motor. Here, the motor control system according to the comparative example supplies a brake signal at a high level to the motor, thereby starting short-circuit braking.

The motor control system according to the comparative example starts short-circuit braking when determining that a pulse signal is stopped, but time t1 at which it is determined that the pulse signal is stopped comes later than time t0 at which the pulse signal is actually stopped as shown in FIG. 3. This is because the motor control system according to the comparative example confirms that there is no subsequent pulse after the pulse signal is stopped, and then determines that the pulse signal is stopped. The motor control system according to the comparative example therefore starts short-circuit braking at the time t1 later than the time t0 at which the pulse signal is actually stopped. This keeps the motor rotating for the lag time from the time t0 to the time t1 (see the hatched portion of FIG. 3). The amount of rotation of the motor then varies during the lag time depending on the load on the motor. This raises the problem that the stop position of the motor tends to vary as with the related art.

In contrast, in this embodiment, a process that is executed by the motor control system 100 of the image forming apparatus 10 described below makes it possible to implement the motor control system 100 and a motor control method that each allow the stop position of the motor 92 to vary less.

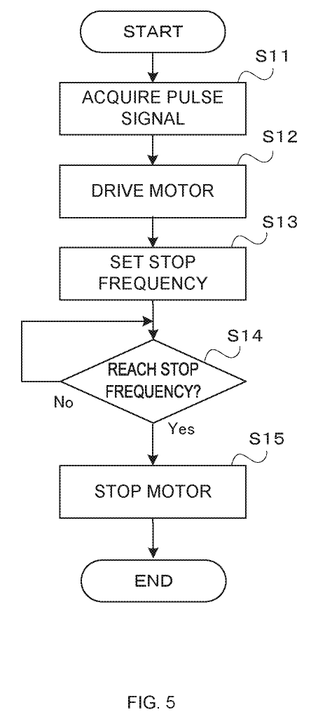

Specifically, the motor control system 100 includes a CPU and a ROM. A program for causing the CPU to execute control (see FIG. 5) described below is stored in advance. It is noted that the program may be recorded in a computer-readable recording medium such as a CD, a DVD, or a flash memory, and read from the recording medium and installed in the storage portion 7.

The motor control system 100 is then a different device from the control device 5 and is a driver that controls the motor. As shown in FIG. 2, the motor control system 100 includes an acquisition portion 101, a setting portion 102, and a control portion 103. Specifically, the motor control system 100 executes the program stored in the ROM using the CPU. This causes the motor control system 100 to function as the acquisition portion 101, the setting portion 102, and the control portion 103. It is noted that the motor control system 100 may be composed of an electronic circuit such as an integrated circuit (ASIC).

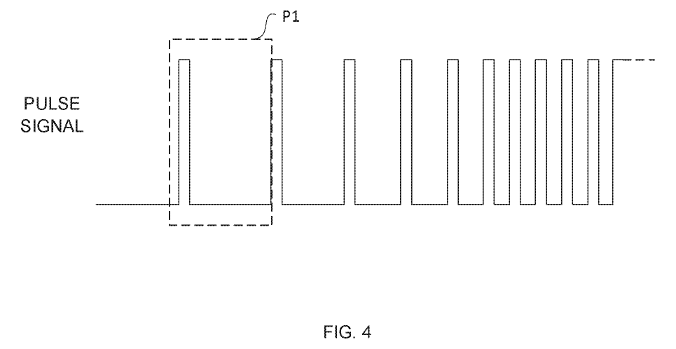

The acquisition portion 101 acquires a pulse signal for an instruction about acceleration and deceleration operations on the motor 92. The pulse signal is output from the pulse generator 8. FIG. 4 is an example of a pulse signal acquired by the acquisition portion 101. The following defines the start of the pulse signal as a transition from a low level (that has persisted for a predetermined time or longer) to a high level as the "start of the pulse signal". In addition, the following defines a pulse signal falling down from the high level to the low level and then remaining at the low level for the predetermined time or more as the "stop of the pulse signal". Here, the predetermined time is a time longer than a period that a pulse signal may have in the acceleration and deceleration operations on the motor 92.

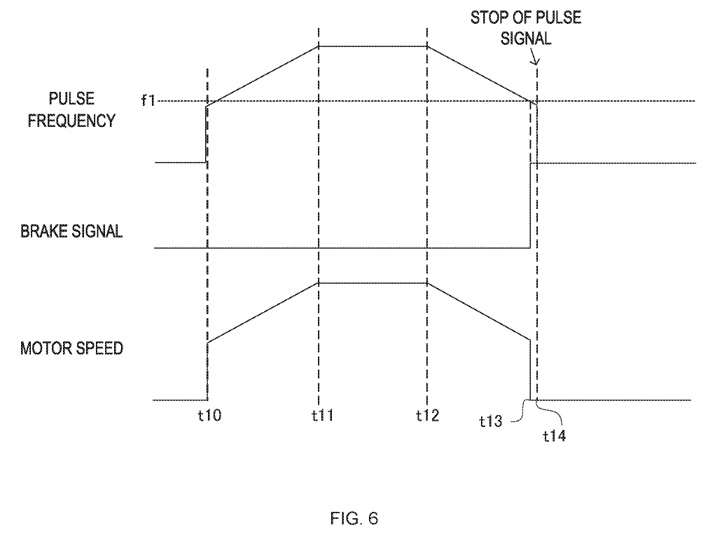

The setting portion 102 sets a stop frequency f1 (see FIG. 6) for the motor 92 on the basis of the frequency of the pulse signal acquired by the acquisition portion 101 at the time of an acceleration operation on the motor 92. The stop frequency f1 corresponds to the stop timing of the pulse signal. Specifically, the setting portion 102 calculates the frequency of the pulse signal acquired by the acquisition portion 101 and corresponding to the stop timing of the pulse signal from the period of the pulse signal and multiplies the calculated frequency of the pulse signal by a coefficient, thereby calculating the stop frequency f1. The coefficient is a value of 1 or more. In this embodiment, the setting portion 102 calculates and sets the stop frequency f1 whenever a pulse signal is started, in other words, whenever acceleration and deceleration operations are performed on the motor 92.

In this embodiment, the setting portion 102 calculates the stop frequency f1 on the basis of an initial pulse P1 (see FIG. 4) of a pulse signal for an instruction to start the motor 92, thereby setting the stop frequency f1. Here, the initial pulse P1 is a pulse observed when a pulse signal is started as shown in FIG. 4. In other words, the initial pulse P1 is the first pulse of a pulse signal. As described below, the control portion 103 controls the speed of the motor 92 on the basis of the pulse frequency of a pulse signal and the frequency of the initial pulse P1 thus corresponds to the initial speed of the motor 92 at the time of acceleration and deceleration operations. In addition, in the acceleration and deceleration operations on the motor 92, the motor 92 is controlled such that the initial speed of the motor 92 and the speed of the motor 92 at the time of the stop of the pulse signal are substantially the same. The frequency of the initial pulse P1 thus corresponds to the frequency of the pulse signal at the stop timing.

In addition, in this embodiment, the stop frequency f1 is set to be greater than the frequency of the initial pulse P1. Specifically, the setting portion 102 calculates the frequency of the initial pulse P1 from the period of the acquired initial pulse P1 and multiplies the calculated frequency by a coefficient of more than 1 (e.g., 1.05), thereby calculating the stop frequency f1.

The control portion 103 controls the motor 92 on the basis of the pulse signal acquired by the acquisition portion 101. Specifically, the control portion 103 decides the duty ratio of a control signal on the basis of the frequency of the pulse signal acquired by the acquisition portion 101. The control portion 103 then supplies the control signal having the decided duty ratio to the motor 92, thereby performing pulse width modulation (PWM) control on the motor 92. Here, the control signal is a binary signal for an instruction to turn on/off a voltage to be supplied to the motor 92 from a power supply (not shown). The control portion 103 then executes a stop process of stopping the motor 92 using short-circuit braking in a case where the frequency of a pulse signal at the time of a deceleration operation on the control portion 103 reaches the stop frequency f1. In the stop process, the control portion 103 supplies a brake signal at the high level to the motor 92, thereby starting short-circuit braking.

In addition, the control portion 103 acquires a pulse output from a detection portion 91 that detects the rotational speed of the motor 92. In this embodiment, the detection portion 91 is an encoder attached to the motor 92. More specifically, the detection portion 91 is a rotary encoder. The control portion 103 then performs feedback control on the motor 92 on the basis of the pulse output from the detection portion 91 such that the speed of the motor 92 remains constant at the speed corresponding to the frequency of the pulse signal acquired by the acquisition portion 101.

### Operation Example of Motor Control System

The following describes an example of the motor control method according to this embodiment along with examples of procedures of processes that are executed by the motor control system 100 in the image forming apparatus 10 with reference to FIG. 5. Here, steps S11, S12, ... denote the numbers of processing procedures (steps) that are executed by the motor control system 100. The process is executed when acceleration and deceleration operations on the motor 92 are started.

### Step S11

First, the acquisition portion 101 acquires a pulse signal output from the pulse generator 8. Hereinafter, the acquisition portion 101 keeps on acquiring pulse signals output from the pulse generator 8.

### Step S12

Next, the control portion 103 drives the motor 92 on the basis of a pulse signal acquired by the acquisition portion 101. Here, the control portion 103 is triggered by the start of the pulse signal to start to drive the motor 92. Hereinafter, the control portion 103 performs PWM control on the motor 92 in accordance with the pulse signal, thereby controlling the speed of the motor 92.

### Step S13

Next, the setting portion 102 sets the stop frequency f1 for the motor 92 on the basis of the frequency of a pulse signal acquired by the acquisition portion 101 at the time of an acceleration operation on the motor 92. Here, the setting portion 102 calculates the stop frequency f1 from the frequency of the initial pulse P1 of the pulse signal, thereby setting the stop frequency f1. It is noted that step S13 may be executed before step S12 or may be executed in parallel with step S12.

### Step S14

The control portion 103 compares the frequency of the pulse signal and the stop frequency f1 set by the setting portion 102 and keeps the motor 92 driven unless the frequency of the pulse signal reaches the stop frequency f1 (step S14: No). The control portion 103 then executes step S15 when the frequency of the pulse signal reaches the stop frequency f1 (step S14: Yes).

### Step S15

The control portion 103 supplies a brake signal at the high level to the motor 92, thereby starting short-circuit braking for the motor 92 to stop the motor 92.

The following describes a specific example of an operation of the motor control system 100 with reference to FIG. 6. FIG. 6 shows an example in which the motor control system 100 according to this embodiment executes acceleration and deceleration operations on the motor 92. The upper part of FIG. 6 shows the waveform of the frequency of a pulse signal. The middle part of FIG. 6 shows the waveform of a brake signal. The lower part of FIG. 6 shows the waveform of the speed (rotation speed) of the motor 92.

First, an operation of the motor control system 100 is started at time t10. The time t10 corresponds to the start time of a pulse signal. Here, the setting portion 102 calculates and sets the stop frequency f1 on the basis of the initial pulse P1 of the pulse signal acquired by the acquisition portion 101. As shown in FIG. 6, the stop frequency f1 is set to be greater than the frequency (that is, the frequency of the initial pulse P1) of the pulse signal at the start time.

After that, the control portion 103 keeps the motor 92 driven in accordance with the pulse signal. In the example shown in FIG. 6, the control portion 103 is executing an acceleration operation on the motor 92 from the time t10 to time t11. In addition, the control portion 103 is executing an operation of keeping the speed of the motor 92 constant from the time t11 to time t12. The control portion 103 is then executing a deceleration operation on the motor 92 after the time t12. Here, the absolute value of the acceleration of the motor 92 at the time of an acceleration operation and the absolute value of the deceleration of the motor 92 at the time of a deceleration operation are the same. That is, the execution time of an acceleration operation on the motor 92 and the execution time of a deceleration operation on the motor 92 are substantially the same.

The control portion 103 then compares the frequency of the pulse signal and the stop frequency f1. When the frequency of the pulse signal reaches the stop frequency f1, the control portion 103 executes a stop process on the motor 92. Here, the frequency of the pulse signal reaches the stop frequency f1 at time t13 and the control portion 103 thus supplies a brake signal at the high level to the motor 92 at the time t13. This stops the motor 92 using short-circuit braking. This time t13 is substantially the same as time t14 at which the pulse signal is stopped. This causes the motor 92 to have substantially the same stop timing as the stop timing of the pulse signal. It is noted that the time t13 seems to be different from the time t14 in FIG. 6, but the time t13 and the time t14 are substantially the same time.

As described above, the motor control system 100 according to this embodiment sets the stop frequency f1 (in other words, the frequency of a pulse signal corresponding to the time of the stop) on the basis of the frequency of a pulse signal at the time of an acceleration operation on the motor 92. The motor control system 100 according to this embodiment then executes a stop process on the motor 92 in a case where the frequency of the pulse signal reaches the stop frequency f1. The motor control system 100 according to this embodiment therefore has no lag time from the stop of a pulse signal to a determination about the stop of the pulse signal unlike the comparative example. It is easier to stop the motor 92 at the timing at which the pulse signal is actually stopped. The motor control system 100 according to this embodiment does not thus vary the amount of rotation of the motor 92 during the lag time depending on the load on the motor 92 and has an advantage that the stop position of the motor 92 less varies.

In addition, in this embodiment, the setting portion 102 sets the stop frequency f1 on the basis of the frequency of the initial pulse P1, that is, the initial speed of the motor 92. This offers an advantage that it is easier to stop the motor 92 at the stop timing of a pulse signal than in a case where the stop frequency f1 is set on the basis of the pulse frequency subsequent to the initial pulse P1 at the time of an acceleration operation on the motor 92. That is, in a case where the stop frequency f1 is set on the basis of the pulse frequency subsequent to the initial pulse P1, the timing at which the frequency of the pulse signal reaches the stop frequency f1 and the stop timing of the pulse signal are different. This makes it difficult to synchronize the stop timing of the motor 92 with the stop timing of the pulse signal. In contrast, in a case where the stop frequency f1 is set on the basis of the frequency of the initial pulse P1, the time at which the frequency of a pulse signal reaches the stop frequency f1 is substantially the same as the stop timing of the pulse signal. This makes it easier to synchronize the stop timing of the motor 92 with the stop timing of the pulse signal.

In addition, in this embodiment, the stop frequency f1 is set to be greater than the frequency of the initial pulse P1, in other words, the frequency of the pulse signal at the time of the stop. This offers an advantage that it is possible to reduce the possibility that the motor 92 is stopped later than the stop timing of a pulse signal in comparison with a case where the stop frequency f1 is set at the frequency of the initial pulse P1. That is, in a case where the stop frequency f1 is set at the frequency of the initial pulse P1, the delay or the like of a pulse signal or a brake signal can make the stop timing of the motor 92 later than the stop timing of the pulse signal. In contrast, the stop frequency f1 is set to be greater than the frequency of the initial pulse P1, thereby restraining the stop timing of the motor 92 from being later than the stop timing of a pulse signal in spite of the delay or the like of the pulse signal or a brake signal.

### Modification

In this embodiment, the setting portion 102 sets the stop frequency f1 in a case where an image formation process is in execution in the image forming apparatus 10. The setting portion 102 does not have to set the stop frequency f1 in a case where no image formation process is in execution. For example, the setting portion 102 acquires, from the control device 5, information indicating whether or not the image forming portion 3 is executing an image formation process. The control portion 103 may then execute a stop process on the motor 92 in a case where the setting portion 102 sets the stop frequency f1. The control portion 103 may wait for the pulse signal to fall down and then stop the motor 92 in a case where the stop frequency f1 is not set. For example, in a case where the stop frequency f1 is set, the control portion 103 executes a stop process on the motor 92 when the frequency of a pulse signal reaches the stop frequency f1 as in this embodiment. In contrast, in a case where the stop frequency f1 is not set, the control portion 103 confirms that there is no subsequent pulse after the pulse signal is stopped, and then executes a stop process on the motor 92 as in the comparative example.

For example, in a case where a roller such as the transfer roller 35, the fixing roller 37, or the pressure roller 38 to be used for an image formation process is driven by the motor 92, the motor 92 is requested to have a highly accurate stop position. In contrast, in a case where a roller such as the conveying roller 42 to be used for a process other than an image formation process is driven by the motor 92, the motor 92 is not requested to have such a highly accurate stop position. This makes it possible in the aspect to execute a stop process on the motor 92 using the stop frequency f1 and secure the motor 92 a highly accurate stop position while an image formation process is in execution. In contrast, a stop process is executed on the motor 92 without setting the stop frequency f1 in the aspect in a case where no image formation process is in execution. This offers an advantage that it is easier to reduce the processing load on the motor control system 100 than in a case where the stop frequency f1 is set all the time.

In addition, in this embodiment, in a case where the contents of acceleration and deceleration operations to be performed on the motor 92 this time are the same as the contents of the acceleration and deceleration operations performed on the motor 92 last time, the setting portion 102 does not have to set the stop frequency f1. For example, the setting portion 102 acquires a job to be executed by the control device 5 and compares the acquired job and the job executed last time and stored in the ROM or the like, thereby determining whether or not the contents of acceleration and deceleration operations to be performed on the motor 92 this time and the contents of the acceleration and deceleration operations performed on the motor 92 last time are the same. The job is, for example, printing on a sheet at designated size, or the like. For example, in a case where a job to be executed this time and the job executed last time designate different sizes, acceleration and deceleration operations to be performed on the motor 92 this time and the acceleration and deceleration operations performed on the motor 92 last time are different. The control portion 103 may then execute a stop process on the motor 92 using the stop frequency f1 used last time in a case where the setting portion 102 does not set the stop frequency f1. For example, the control portion 103 reads the stop frequency f1 used at the time of the acceleration and deceleration operations performed on the motor 92 last time and stored in the ROM or the like and executes a stop process on the motor 92 using the read stop frequency f1. The aspect has the advantage that it is easier to reduce the processing load on the motor control system 100 than in a case where the stop frequency f1 is set all the time.

### Supplementary Notes of Disclosure

The gist of the disclosure extracted from the embodiment described above will be supplementarily noted below. It is noted that the respective configurations and the respective processing functions described in the following supplementary notes can be sorted out and used in any combination.

### Supplementary Note 1

A motor control system including:

an acquisition portion configured to acquire a pulse signal for an instruction about acceleration and deceleration operations on a motor;

a setting portion configured to set a stop frequency for the motor on the basis of a frequency of the pulse signal at time of an acceleration operation on the motor, the stop frequency corresponding to a stop timing of the pulse signal; and

a control portion configured to execute a stop process of stopping the motor using short-circuit braking in a case where a frequency of the pulse signal at time of a deceleration operation on the motor reaches the stop frequency.

### Supplementary Note 2

The motor control system according to Supplementary Note 1, in which the setting portion sets the stop frequency by calculating the stop frequency on the basis of a frequency of an initial pulse of the pulse signal, the initial pulse being for an instruction to start the motor.

### Supplementary Note 3

The motor control system according to Supplementary Note 2, in which the stop frequency is greater than the frequency of the initial pulse.

### Supplementary Note 4

The motor control system according to any one of Supplementary Notes 1 to 3, in which the motor drives a roller configured to convey a sheet in an image forming apparatus.

### Supplementary Note 5

The motor control system according to Supplementary Note 4, in which

the setting portion sets the stop frequency in a case where an image formation process is in execution in the image forming apparatus, and the setting portion does not set the stop frequency in a case where the image formation process is not in execution, and

the control portion executes the stop process in a case where the stop frequency is set, and the control portion waits for the pulse signal to fall down and then stops the motor in a case where the stop frequency is not set.

### Supplementary Note 6

The motor control system according to any one of Supplementary Notes 1 to 5, in which

in a case where a content of acceleration and deceleration operations to be performed on the motor this time is same as a content of acceleration and deceleration operations performed on the motor last time, the setting portion does not set the stop frequency, and

the control portion executes the stop process using the stop frequency used last time in a case where the setting portion does not set the stop frequency.

### Supplementary Note 7

A motor control method including:

an acquisition step of acquiring a pulse signal for an instruction about acceleration and deceleration operations on a motor;

a setting step of setting a stop frequency for the motor on the basis of a frequency of the pulse signal at time of an acceleration operation on the motor, the stop frequency corresponding to a stop timing of the pulse signal; and

a control step of stopping the motor using short-circuit braking in a case where a frequency of the pulse signal at time of a deceleration operation on the motor reaches the stop frequency.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A motor control system comprising:
an acquisition portion configured to acquire a pulse signal for an instruction about acceleration and deceleration operations on a motor;
a setting portion configured to set a stop frequency for the motor based on a frequency of the pulse signal at time of an acceleration operation on the motor, the stop frequency corresponding to a stop timing of the pulse signal; and
a control portion configured to execute a stop process of stopping the motor using short-circuit braking in a case where a frequency of the pulse signal at time of a deceleration operation on the motor reaches the stop frequency.

2. The motor control system according to claim 1, wherein the setting portion sets the stop frequency by calculating the stop frequency based on a frequency of an initial pulse of the pulse signal, the initial pulse being for an instruction to start the motor.

3. The motor control system according to claim 2, wherein the stop frequency is greater than the frequency of the initial pulse.

4. The motor control system according to claim 1, wherein the motor drives a roller configured to convey a sheet in an image forming apparatus.

5. The motor control system according to claim 4, wherein
the setting portion sets the stop frequency in a case where an image formation process is in execution in the image forming apparatus, and the setting portion does not set the stop frequency in a case where the image formation process is not in execution, and
the control portion executes the stop process in a case where the stop frequency is set, and the control portion waits for the pulse signal to fall down and then stops the motor in a case where the stop frequency is not set.

6. The motor control system according to claim 1, wherein
in a case where a content of acceleration and deceleration operations to be performed on the motor this time is same as a content of acceleration and deceleration operations performed on the motor last time, the setting portion does not set the stop frequency, and
the control portion executes the stop process using the stop frequency used last time in a case where the setting portion does not set the stop frequency.

7. A motor control method comprising:
an acquisition step of acquiring a pulse signal for an instruction about acceleration and deceleration operations on a motor;
a setting step of setting a stop frequency for the motor based on a frequency of the pulse signal at time of an acceleration operation on the motor, the stop frequency corresponding to a stop timing of the pulse signal; and
a control step of executing a stop process of stopping the motor using short-circuit braking in a case where a frequency of the pulse signal at time of a deceleration operation on the motor reaches the stop frequency.
